(19) United States
(12) Patent Application Publication
(10) Pub. No.: US 2010/0032582 A1
(43) Pub. Date: Feb. 11, 2010

(54) FLUORESCENCE DETECTION SYSTEM AND METHOD

(75) Inventors: Hua Xia, Altamont, NY (US); Li Zhu, Clifton Park, NY (US); Eugene Barash, Niskayuna, NY (US); Erin Jean Finehout, Clifton Park, NY (US); Matthew Damian Pietrzykowski, Clifton Park, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/187,815

(22) Filed: Aug. 7, 2008

(51) Int. Cl. G01N 21/64

(52) U.S. Cl. 250/458.1

(57) ABSTRACT

A fluorescence detection system comprises a light source configured to produce an excitation light, an optical lens and a fiber bundle. The optical lens is configured to focus the excitation light to a sample to emit fluorescence and to collect the fluorescence. The fiber bundle probe comprises a transmitting fiber configured to transmit the excitation light to the optical lens, and a first receiving fiber configured to deliver the collected fluorescence. The fluorescence detection system further comprises a first detector configured to detect the fluorescence delivered by the receiving fiber to generate a response signal, and a processing unit configured to determine information about the samples by analyzing the response signal. Additionally, a fluorescence detection method is also presented.

### BACKGROUND

This invention relates generally to a fluorescence detection system and a method for detecting fluorescence. More particularly, this invention relates to a fluorescence detection system for a lab-on-a-chip and a method for detecting fluorescence from the lab-on-a-chip.

A lab-on-a-chip, also named a microfluidic chip or a microchip, is a miniaturized device for manipulating and analyzing chemical/biological samples in micrometer-sized channels thereof. The lab-on-a-chip can be fabricated by a micro-machining techniques, such as photolithography, wet etching, or laser ablation, and is referred to as a chemical/biological microprocessor including a variety of processes (such as sample pretreatment, injection, reaction, separation and detection) integrated in a glass, silicon, or plastic substrate of an area of several square centimeters. It offers faster analysis while using much smaller amount of samples and reagents, usually on a micro-liter scale. This microfluidic chip has promised to be a next generation chemical/biological analysis platform.

Nowadays, the microfluidic chip has been used for protein separation in an electrophoresis format and it has shown great advantages over the conventional sodium dodecyl sulfate polyacrylamide gel electrophoresis (SDS-PAGE) method for protein separation because of its high-speed and small-scale analyte requirement. However, such a small-scale analysis causes very high requirements on its detection system in terms of sensitivity and selectivity etc.

Fluorescence has been widely used as a detection method for bio-molecules, such as proteins or DNAs due to its high sensitivity. And a most widely used fluorescence detector coupled to a microfluidic chip is a Laser Induced Fluorescence (LIF) detection system. Usually, the LIF detection system is based on free-space optics (lens, mirrors, dichroic filters). The other LIF detection system is based on waveguides and optics devices both embedding in a microfluidic chip to deliver excitation light from a light source, such as a laser source or a light emitting diode (LED) source, and pick up fluorescence. However, it is time-consuming and cost-ineffective to embed the waveguides and the optics devices in a very small microfluidic chip. Moreover, it is very difficult to replace any parts of the detection system without a complicated alignment and calibration.

In addition, the LIF detection system has fibers to couple with and to deliver the excitation light into the respective waveguides, it further adds more complexity to the microfluidic chip fabrication due to the matching requirement of the fibers coupling with the respective waveguides in numerical aperture and in fiber core and waveguide size.

Therefore, there is a need for a new and improved fluorescence detection system in a lab-on-a-chip and a method for detecting the fluorescence from the lab-on-a-chip.

### BRIEF DESCRIPTION

A fluorescence detection system is provided in accordance with one embodiment of the invention. The fluorescence detection system comprises a light source configured to produce an excitation light, an optical lens and a fiber bundle. The optical lens is configured to focus the excitation light to a sample to emit fluorescence and to collect the fluorescence. The fiber bundle probe comprises a transmitting fiber configured to transmit the excitation light to the optical lens, and a first receiving fiber configured to deliver the collected fluorescence. The fluorescence detection system further comprises a first detector configured to detect the fluorescence delivered by the receiving fiber to generate a response signal, and a processing unit configured to determine information about the samples by analyzing the response signal.

Another embodiment of the invention provides a fluorescence detection method. The fluorescence detection system comprises producing an excitation light from a light source, focusing the excitation light on a sample by an optical lens to emit fluorescence and collecting the fluorescence using the optical lens, transmitting the excitation light through a transmitting fiber to the optical lens, passing the collected fluorescence through a first receiving fiber to a detector, detecting the colleted fluorescence to generate a response signal, and determining information about the sample by analyzing the response signal.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a schematic diagram of a fluorescence detection system in accordance with one embodiment of the invention;

FIG. 2 is a schematic diagram of the fluorescence detection system in accordance with another embodiment of the invention;

FIG. 3 is a schematic diagram of the fluorescence detection system in accordance with yet another embodiment of the invention;

FIG. 4 is a schematic diagram of a configuration of a fiber bundle probe, an optical lens and a microchip in accordance with one embodiment of the invention;

FIG. 5 is a schematic diagram of a configuration of a fiber bundle probe, an optical lens and a microchip in accordance with another embodiment of the invention;

FIG. 6 is a schematic diagram of assembly of distal ends of fibers of the fluorescence detection system in accordance with one embodiment of the invention;

FIG. 7 is a schematic diagram useful in explaining how to reduce overlapping of an excitation light and fluorescence;

FIG. 8 is an intensity profile used in finding axial focusing position in a microfluidic chip without a protein sample therein;

FIG. 9 is a schematic diagram useful in explaining the optical lens focusing positions at different microchip locations; and

FIG. 10 is an intensity profile used in finding horizontal focusing position in a microfluidic chip with a protein sample therein.

### DETAILED DESCRIPTION OF THE DISCLOSURE

Preferred embodiments of the present disclosure will be described hereinbelow with reference to the accompanying drawings. In the following description, well-known functions or constructions are not described in detail to avoid obscuring the disclosure in unnecessary detail.

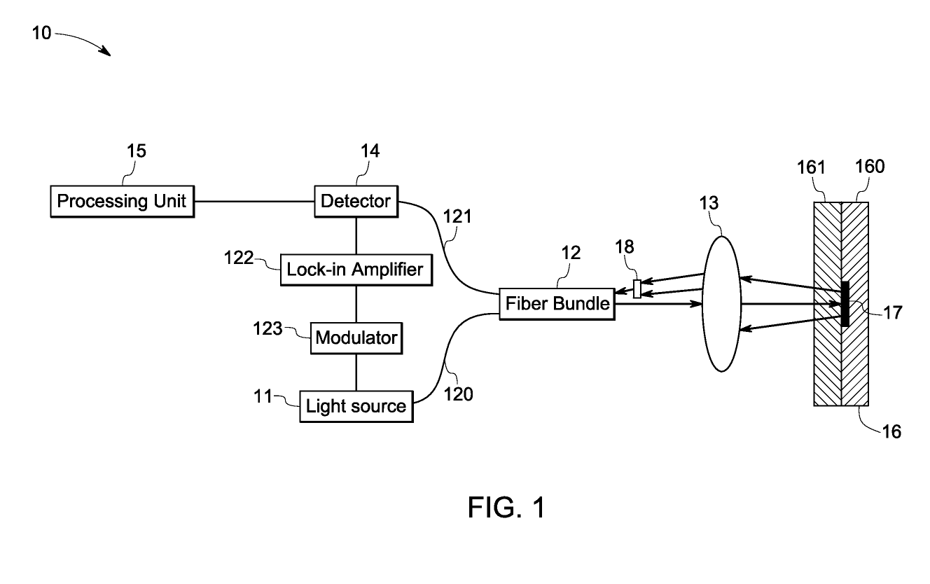

FIG. 1 illustrated a schematic diagram of a fluorescence detection system 10 in accordance with one embodiment of the invention. The fluorescence detection system 10 comprises a light source 11, a fiber bundle probe 12, an optical lens 13, a detector 14 and a processing unit 15. In embodiments of the invention, the light source 11 comprises a frequency modulated laser source or a light emitting diode (LED) source with a laser light fiber. The fiber bundle probe 12 comprises a transmitting fiber 120 and at least one receiving fiber 121. The optical lens 13 comprises a microscope objective or an aspheric lens. The detector 14 comprises a silicon-based photo detector or an avalanche photodiode detector, and the processing unit 15 may be a personal computer equipped with data processing software. The elements in embodiments of the invention are available and easily implemented by one skilled in the art.

In embodiments of the invention, the light source 11 is for producing an excitation light with a typical wavelength range from 365 nm to 532 nm, and a frequency modulation from 3 kHz to 200 MHz. The transmitting fiber 120 is coupled to the light source 11 for transmitting the excitation light to the optical lens 13, and the optical lens 13 focuses the excitation light on samples in an electrophoresis channel 17 of a microfluidic chip 16 to emit fluorescence. Meanwhile, the optical lens 13 and the receiving fiber 121 collect the fluorescence and transmit the collected fluorescence signal to the detector 14. Then, the detector 14 detects the frequency modulated fluorescence signal, and generates a response signal, such as an electrical signal, in response to the detected fluorescence.

Finally, the processing unit 15 determines information about the samples by analyzing the electrical signal generated by the detector 14. For example, the processing unit 15 analyzes intensity, lifetime, or spectra of the detected fluorescence indicated by the generated electrical signal to determine materials in, or characteristics of, the samples.

In certain embodiments of the invention, the detector 14 may be the photodiode, such as an avalanche photodiode or a PIN photodiode. Alternatively, the detector 14 may be a photomultiplier tube. Generally, the avalanche photodiode (APD) is more sensitive than the PIN photodiode. The photomultiplier tube is generally more sensitive than the avalanche photodiode and much more sensitive than the PIN photodiode, but is also much larger and needs a high voltage supply. The avalanche photodiode, the PIN photodiode and the photomultiplier tube are known devices. However, the invention is not limited to the detector 14 being a photodiode or a photomultiplier tube. For example, a spectrometer may be used as the detector 14 for spectral analysis.

In the illustrated embodiment of the invention, the light source 11 may be a laser source. The optical lens 13 may be an aspheric lens and the detector 14 may be an avalanche photodiode for detecting the fluorescence, whose intensity or lifetime can be analyzed in the processing unit 15. Additionally, a depth and the width of the channel 17 in the microfluidic chip may be 10-50 μm and 20-100 μm, respectively. A focused light spot size of the excitation light on the channel 17 may be 1.2-2 times larger than a width of the channel 17 to minimize non-uniform fluorescence emission.

As illustrated in FIG. 1, the optical lens 13 can collect light scattered from the samples, and the collected light generally comprises the excitation light and the excited fluorescence. Therefore, the fluorescence detection system 10 may further comprise a filter 18 integrated into a distal end of the receiving fiber for filtering the excitation light from the light source 11. In one embodiment, the filter 18 may be a long-pass filter for passing the fluorescence but block the laser light, which is known to one skilled in the art. In certain embodiments, the filter 18 may be disposed between the distal end of the receiving fiber 121 and the optical lens 13. Alternatively, the filter 18 may be disposed in a proximal end of the receiving fiber 121 connected to the detector 14. Additionally, the optical lens 13 may be integrated into the distal end of the fiber bundle probe 12.

In embodiments of the invention, in order to exclude interference of an ambient environment so as to improve accuracy of the system to a certain desired level, the fluorescence detection system 10 further comprises a dual-phase lock-in amplifier circuit 122 coupled to the APD 14, and a frequency modulator 123 coupled to the dual-phase lock-in amplifier circuit 122 and the light source 11 respectively. The cooperation of the dual-phase lock-in amplifier circuit 122 and the frequency modulator 123 can significantly improve the signal-to-noise ratio of the system, and make it possible to use the system 10 in an ambient environment. The dual-phase lock-in amplifier circuit 122 and the frequency modulator 123 are known devices.

The fiber bundle probe 12 may comprise at least two fibers, one for light delivering (transmitting) and one for fluorescence receiving. In embodiments of the invention, the fiber bundle probe 12 may comprise 1 to N fibers for light delivering and 1 to N fibers for receiving fluorescence. In one embodiment, there are six fibers as receiving fibers that are symmetrically surrounding the central light delivering fiber. In certain embodiments of the invention, N fibers for light delivering and N fibers for fluorescence receiving, these fibers may be configured in a pattern of random, coaxial, half-and-half, or symmetrical rings.

The fibers in the fiber bundle probe 12 could be single mode or multimode silica fibers. Fiber core diameters of the fibers could range from 4 microns to 1000 microns, and fiber-cladding diameters thereof could range from 125 microns to 1200 microns. For the delivering fibers, the fiber core could be pure silicon dioxide material without any doping but the fiber cladding may be doped with phosphorus, fluorine, chlorine etc. On the other case, silica fiber cladding has no any doping but the fiber core is doped with GeO2, B2O3, Er, and other ions. These fibers should be ultraviolet grade fibers to avoid laser absorption, darkness effect, and fiber itself fluorescence for short-wavelength laser delivery.

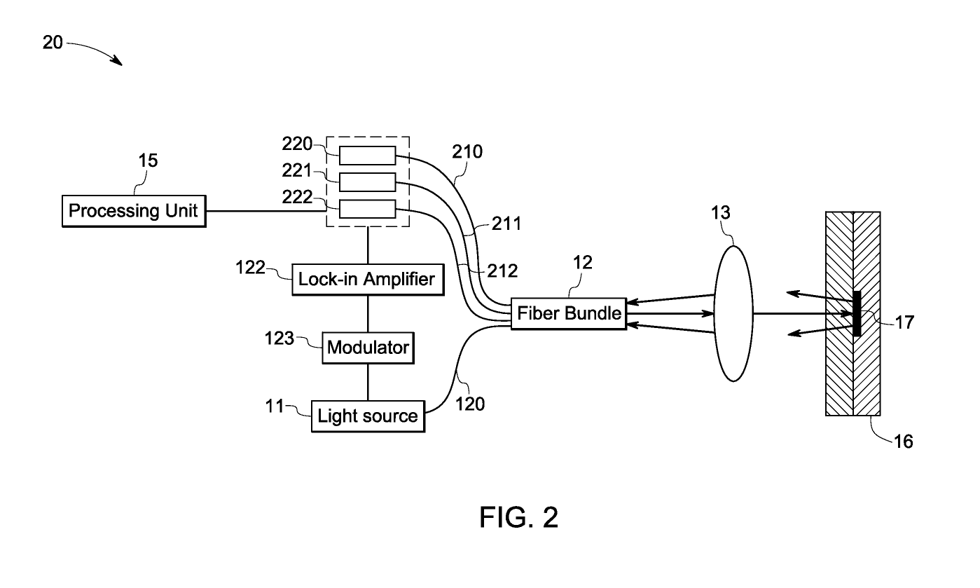

FIG. 2 illustrates a schematic diagram of a fluorescence detection system 20 in accordance with another embodiment of the invention. The embodiment in FIG. 2 is similar to that in FIG. 1, and the same numerals in FIGS. 1-2 can stand for the same elements. In embodiments of the invention, one single receiving fiber, such as the receiving fiber 121 in FIG. 1, may be provided to transmit partial fluorescence for intensity analysis, spectral analysis or imaging analysis. However, one receiving fiber may be not enough for subsequent sample analysis.

Therefore, in the illustrated embodiment in FIG. 2, the fluorescence detection system 20 comprises the fiber bundle probe 12 including more than one receiving fibers that can improve the signal-to-noise ratio of the system when all the receiving fibers are use for fluorescence intensity analysis, spectra, imaging or lifetime analyses. In particular, the fiber bundle probe 12 comprises a first receiving fiber 210, a second receiving fiber 211 and a third receiving fiber 212 to deliver partial fluorescent signal to different detectors or analytical system. In certain embodiments, the fluorescence detection system 20 may comprise a first detector 220 to connect to the first receiving fiber 210, a second detector 221 to connect to the second receiving fiber 211, and a third detector 222 to connect to the third receiving fiber 212. The detectors 220-222 are also connected to the processing unit 15. In one embodiment, the detectors 220-222 are the avalanche photodiodes, spectrometers, or photomultiplier tubes. In particular, the first and second detectors 210 and 221 are the avalanche photodiodes, and the third detector 222 is an UV-VIS (Ultraviolet-Visible Light) spectrometer.

Therefore, the fluorescence detection system 10 can analyze the intensity, lifetime, and/or spectra of the excited fluorescence simultaneously in one time. Additionally, the fluorescence detection system 20 may provide more receiving fibers, and more detectors, such as the avalanche photodiodes and/or UV-VIS spectrometers. Further, the dual-phase lock-in amplifier circuit 122 and the frequency modulator 123 may be or not be provided to couple with the detectors and the light source 11. And more filters, such as three, are disposed to match respective receiving fibers 210-212.

In embodiments of the invention, the light source 11 in FIGS. 1-2 may produce the excitation light with specifically desired wavelength from 365 nm to 532 nm to excite the materials in the samples to emit the fluorescent with certain wavelength. However, different materials in the samples may need to be excited by the excitation light with different wavelengths, or the generated excitation light is not suitable for exciting a known material in the samples. Therefore, it is advantageous to provide different light sources to meet different applications.

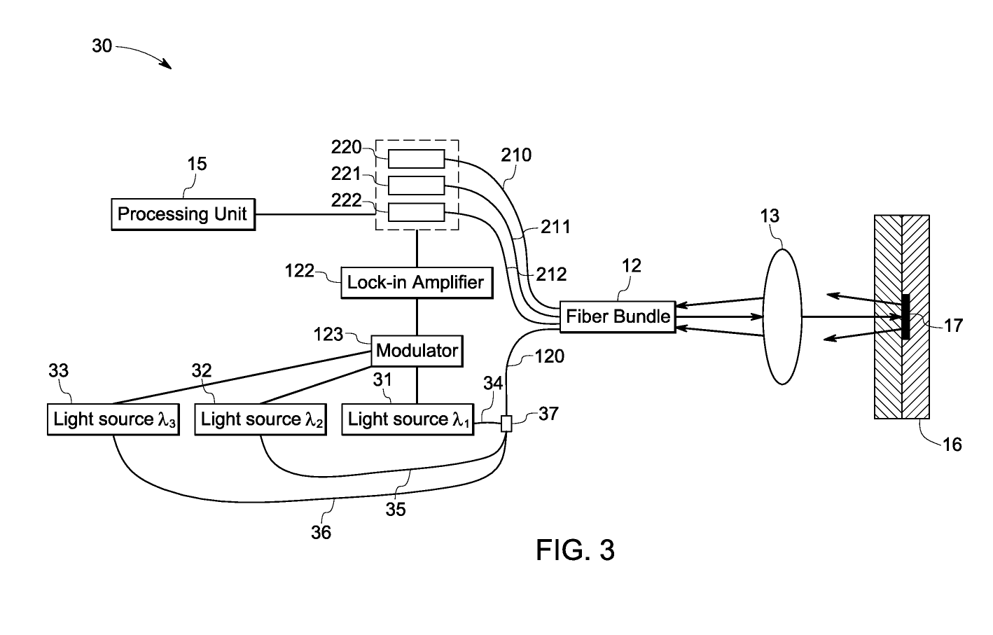

FIG. 3 illustrates a schematic diagram of a fluorescence detection system 30 in accordance with yet another embodiment of the invention. The embodiment in FIG. 3 is similar to that in FIG. 2, and the same numerals therein may be the same elements. In the illustrated embodiment in FIG. 3, the fluorescence detection system 30 comprises more than one light sources, for example a first light source 31 for generating a first excitation light with a first wavelength λ1, a second light source 32 for generating a second excitation light with a second wavelength λ2, and a third light source 33 for generating a third excitation light with a third wavelength λ3. The different light sources may connect to respective connecting fibers 34, 35 and 36. The connecting fibers 34, 35 and 36 connect to the transmitting fiber 120 via an optical coupler 37, which is specifically designed for ultraviolet light and visible light coupling.

During operation, one light source can work individually, or more than one light sources can work simultaneously. Additionally, the fluorescence detection system 30 may comprise one or more detectors. The dual-phase lock-in amplifier circuit 122 and the frequency modulator 123 may be or not be provided to couple with the detector(s) and the light sources. More filters are disposed to match respective receiving fibers 210-212.

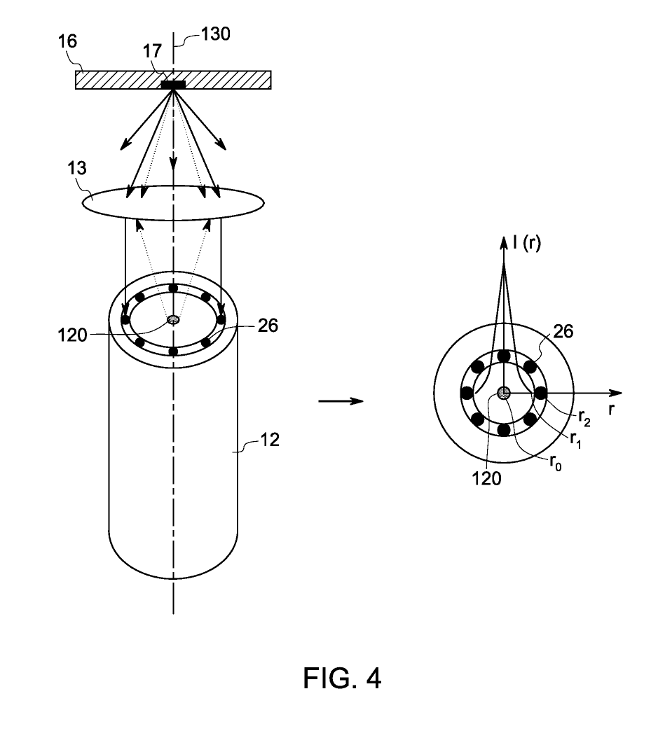

FIG. 4 shows a coaxial configuration for the light delivery and the fluorescence receiving sub-system setup. Here the fiber bundle probe 12 is about 30±5 mm far from the optical lens 13. The fiber bundle probe 12 may comprise a central fiber, such as the transmitting fiber 120 with a radius of rₒ for transmitting the excitation light, and receiving fibers 26 are symmetrically surrounding the central fiber 120 for receiving fluorescence. The optical lens 13 has an optical axis 130. When the fiber bundle probe 12 is coaxial with the optical lens 13 and the microchip 16, the backscattered laser intensity I(r) at r₁ should be negligible, or I(r₁)≈0. This requires the receiving fibers 26 should be distributed with a radial distance r₂>r₁.

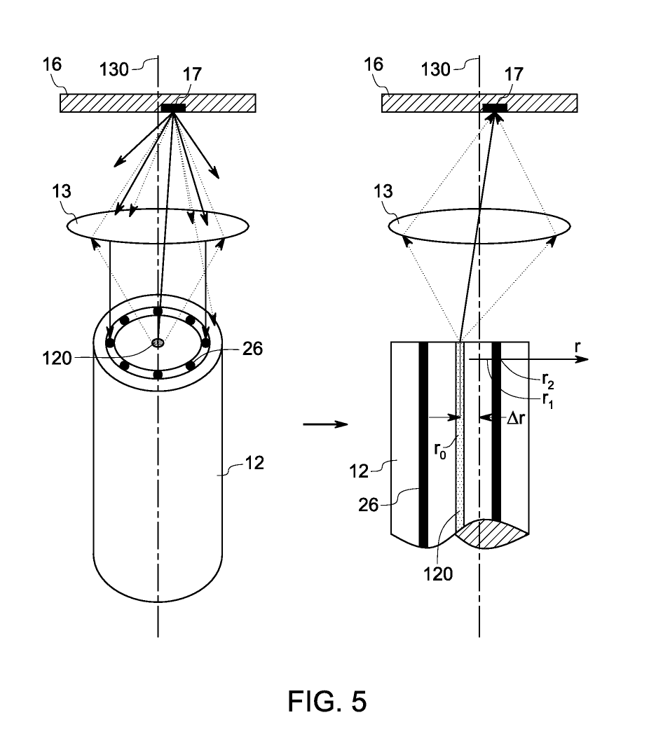

In certain embodiments of the invention, FIG. 5 shows an off-axial configuration for light delivery and fluorescence receiving sub-system setup. Here the fiber bundle probe 12 is also about 30±5 mm far from the optical lens 13. The fiber bundle probe 12 may comprise the central fiber 120 for transmitting the excitation light, and the receiving fibers 26 are symmetrically surrounding the central fiber 120 for receiving fluorescence. When the fiber bundle probe 12 is off-axis Δr distance from the optical lens axis 130, the receiving fibers 26 should be distributed with a radial distance r₂<2Δr. Thus, avoiding any interference of backscattered laser intensity to the fluorescence signal.

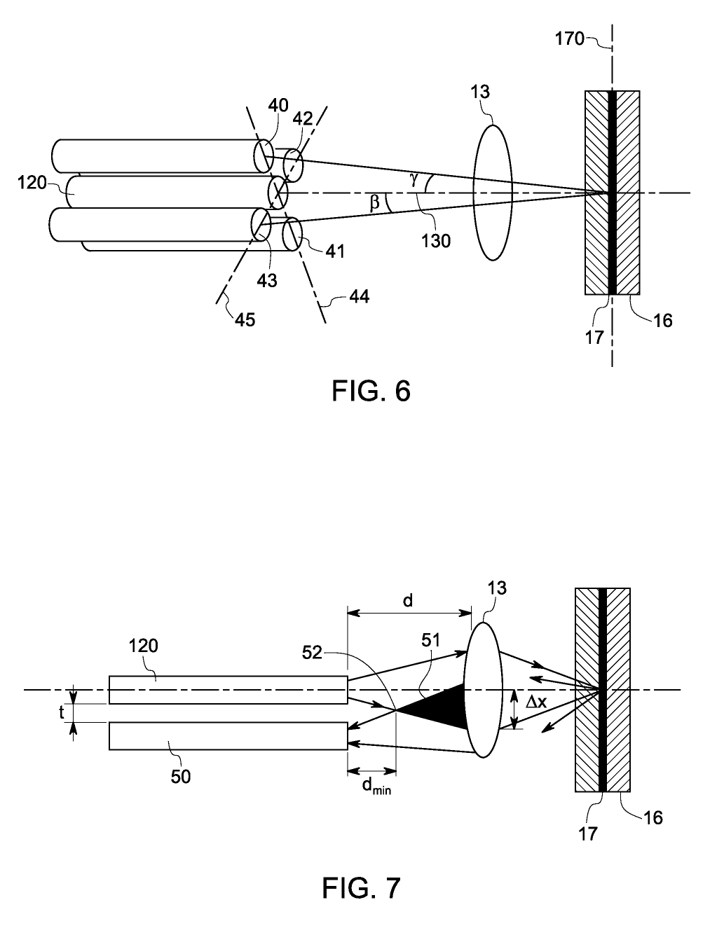

FIG. 6 illustrates a schematic diagram of assembly of the distal ends of the fibers in the fiber bundle probe 12 in accordance with one embodiment of the invention. In embodiments of the invention, the microfluidic chip 16 defines one or more channels 17, and the channel 17 is accommodated with the samples for analysis. The channel 17 has an axis 170, and the optical lens 13 has the optical axis 130. The distal end of the transmitting fiber 120 locates on the optical axis 130 of the optical lens 13. In particular, an axis of the distal end of the transmitting fiber 120 is overlapping with the optical axis 130. The distal end(s) of the receiving fiber(s) may offset from the optical axis 130 in a certain angle α and/or β, such as 2 degrees.

In the illustrated embodiment, taking the fiber bundle probe 12 including five fibers as an example, that is, the fiber bundle probe 12 may comprise the transmitting fiber 120 and four receiving fibers 40, 41, 42 and 43. A line 44 connecting two central points of distal end planes (not labeled) of the receiving fibers 40-41 is parallel to the axis of the channel 17. And a line 45 connecting two central points of distal end planes (not labeled) of the receiving fibers 42-43 is perpendicular to the axis of the channel 17. Additionally, the receiving fiber 40 or 41 may offset from the optical axis 130 in a vertical angle α. And the receiving fiber 42 or 43 may offset from the optical axis 130 in a plane angle β. As will be appreciated, a central point of a distal end plane of the transmitting fiber 120 may locate on the lines 44 and 45 simultaneously. That is, a line connecting two central points of distal end planes of a receiving fiber and a transmitting fiber may be parallel or perpendicular to the axis 170 of the channel 17.

In embodiments of the invention, the fluorescence detection system may comprises more than one transmitting fibers. In one embodiment, the transmitting fibers may form a transmitting fiber bundle probe (not shown) received in the fiber bundle probe 12. In particular, the transmitting fiber bundle probe may locate on the optical axis 130 of the optical lens 13. Additionally, the fiber bundle probe 12 may comprise more receiving fibers, which may be divided into different receiving fiber groups. However, these fibers have to be distributed in the location where the elastic scattered laser light intensity is negligible.

FIG. 7 illustrated a schematic diagram useful in explaining how to reduce overlapping of the excitation light and the fluorescence. In embodiments of the invention, the filter is employed to eliminate the interference of the excitation light. Further, the excitation light may be reduced to enter into the receiving fiber(s) by layout of the fibers in the fiber bundle probe 12 and the optical lens 13.

For convenient illustration, in the illustrated embodiment, two fibers are illustrated. As illustrated in FIG. 7, the transmitting fiber 120 delivers the excitation light to pass the optical lens 13 to focus on the channel 17 in the microfluidic chip 16. And a receiving fiber 50 collects the scattered fluorescence from the samples after the fluorescence passes through the optical lens 13. Therefore, the excitation light may overlap partly with the fluorescence in an area 51 to influence subsequent analysis. An overlapped height of the area 51 is ΔX. Furthermore, “d” refers a distance between distal ends of the fibers and the optical lens 13. A minimum distance from the distal ends of fibers to a peak point 52 of the overlapped area 51 may be referred to as “dmin”. A distance between the two fibers 120 and 50 may be defined as “t”. In embodiments of the invention, “d” may be larger than or equal to “dmin”.

In the illustrated embodiment, dmin=Φ/2 tan φ, NA=n sin φ=0.22, and ΔX=2d tan φ−t. Wherein, “Φ” is a fiber diameter, “φ” is a fiber maximum light-receiving angle, NA is a fiber numerical aperture, and “n” is a fiber core refractive index. In particular, the fiber diameter, the numerical aperture, and the core refractive index may be predetermined. Therefore, the fiber maximum light-receiving angle φ and “dmin” may be determined. And the overlapped height ΔX can be adjusted by varying the “d” and “t”. Thus, in embodiments of the invention, changing the “d” and “t” can adjust the overlapped area 51 so as to reduce the excitation light collected by the receiving fiber(s) to improve the signal-to-noise ratio of the system. Meanwhile, changing “d” can set the receiving fiber or fibers at a radial location where the elastic scattered laser light intensity is negligible.

Although above fiber optic based on fluorescence detection system and sub-system can be used for microchip sample fluorescence analysis, it is not a trivial task in how to focus the laser light on the microchip channel position without automation. The following presents a mechanical/optical method to accurately find the microchip channel by laser intensity signature. As illustrated in FIG. 1, taking the detection system 10 in FIG. 1 as an example. Generally, the microfluidic chip 16 comprises a substrate layer (a bottom chip) 160 and a cover layer (an upper chip) 161 attached to the substrate layer 160, which may be made of a solid material, such as glass, silicon, plastic, or ceramic. The channels 17 are defined between the substrate layer 160 and the cover layer 161 for accommodating the samples, which is known to one skilled in the art. However, in practice, it is often difficult to quickly find positions of the channels 17 for sample analysis due to very small size of the channels 17 and generally dark operation environment, specifically while there is no automatically mechanical channel positioning device available.

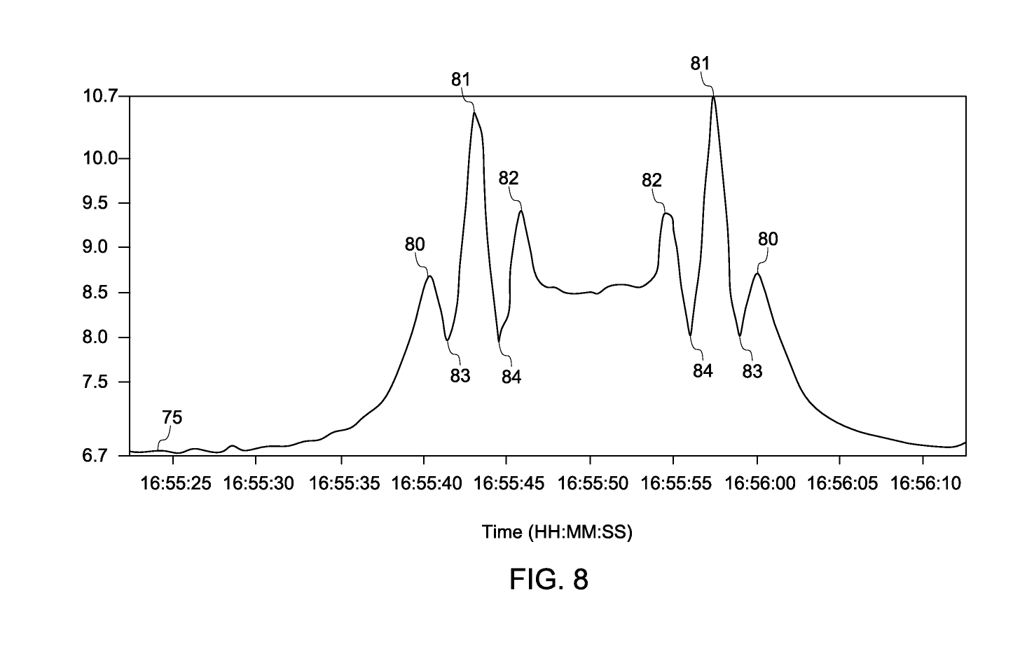

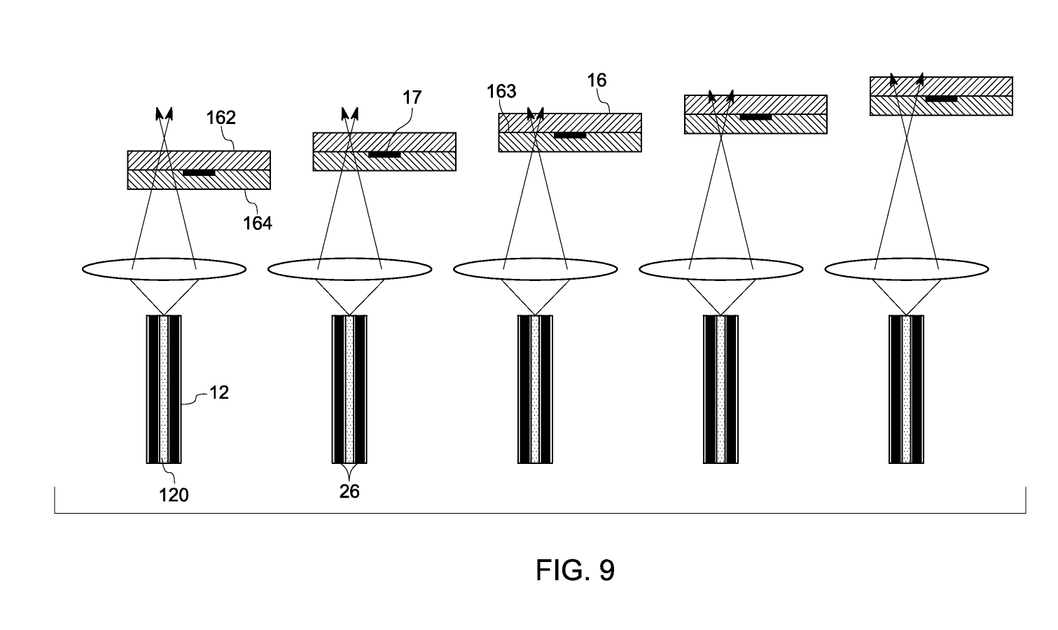

The mechanical/optical micro-channel search method is based on “Three-peak” signature as shown in FIG. 8. This intensity profile is taken form outside of the microfluidic channel and the long-pass filter is moved out from detection path. Finding micro-channel location is based on axial and horizontal alignments. First alignment could be axial alignment, then, follows a horizontal alignment.

As illustrated in FIGS. 8-9, the microfluidic chip 16 may be moved to an adjacent focal plane of the optical lens 13 from a position away from the adjacent focal plane thereof to accomplish the axial alignment. During this axial movement, the intensity becomes stronger from a baseline 75 in FIG. 8. Then, three peaks 80-82 in FIG. 8 show up as the intensity signatures. When moving the microchip 16 back to initial axial position, the intensity signature of the “Three-peak” is mirrored back.

In one embodiment, as shown in FIGS. 1 and 8-9, three peaks 80-82 arise from upper and bottom chip/air interfaces 162 and 164, and an upper and bottom half chip interface (middle interface) 163. The three peaks 80-82 are produced when the optical lens focusing position passes through the each interface 162-164. In a general case, the first peak 80 corresponds to the upper air/chip interface 162, and the second peak 81 from the middle chip interface 163, and the third peak 82 from the bottom chip/air interface 164. Among three peaks, there are two intensity dips 83 and 84. Since the micro-channel 17 is produced in the substrate layer 160, the first intensity dip 83 is associated with the focusing position just in-between the upper and middle interfaces 162 and 163 of the microchip 16. The second intensity dip 84 is associated with the focusing position just in-between the middle and bottom interfaces 163 and 164 of the microchip 16.

Then, the horizontal alignment can be done by first setting the microchip 16 either at one peak position or one dip position as shown in FIG. 8, then, align the microchip channel 17 from one side to across the laser focusing point. At the micro-channel location, the rectangle waveguide-like channel 17 make elastic scattering light stronger than outside the channel area from its edges and some irregularities from channel walls. Setting the microchip 17 in the maximum intensity position indicates the horizontal mechanical alignment is accomplished.

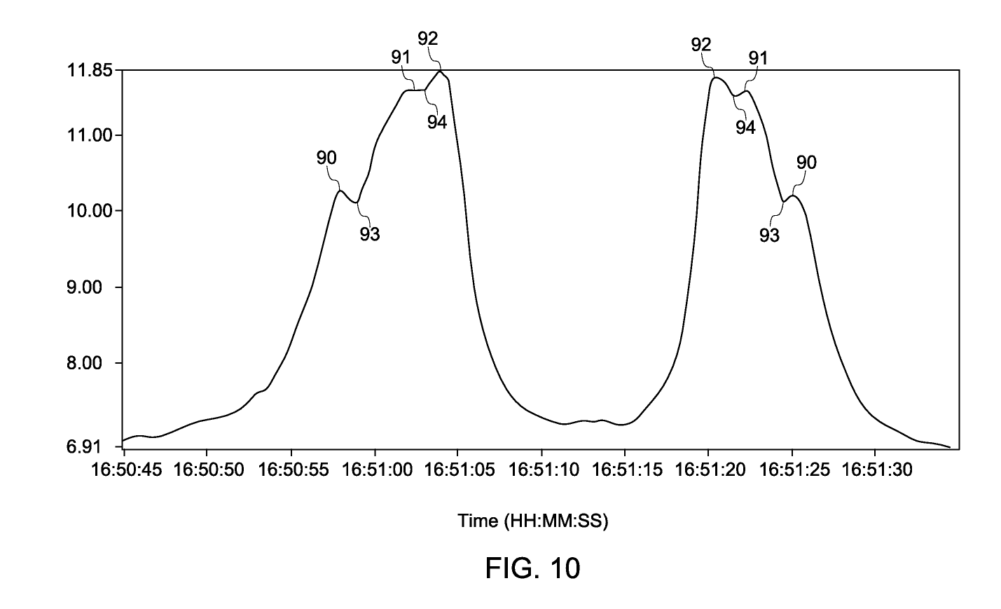

In embodiments of the invention, the exact micro-channel location can be verified by setting the microchip position either at one of three peaks or at one of two intensity dips. FIGS. 9 and 10 can verify the excitation light is focused on an area having the channel. In one embodiment, the intensity profile in FIG. 10 can indicate the excitation light is focused on an area defining the channel 17. Similar to the intensity profile in FIG. 8, first, second and third intensity peaks 90-92 in FIG. 8 denote intensities of the collected light when the excitation light is focused on the upper surface 162 of the cover layer 161, the middle interface 163 of the cover layer 161 and the substrate layer 160, and the lower surface 164 of the substrate layer 160 in the area defining the channel 17, respectively. In particular, the middle intensity peak 64 denotes the excitation light is focused on the connection part 163 in the area defining the channel 17, so that the channel 17 can be found. In this profile, the intensity peaks 90-92 dominated by three interfaces scattering with weaker fluorescence signal. However, a first dip 93 shows its sensitivity to detect fluorescence signal much better than in the peak positions, but a second dip 94 shows highest sensitivity of the fluorescence signal detection.

Therefore, analyzing the three intensity peaks in the respective intensity profiles in FIGS. 8-10 can quickly find the position of the channel 17 in the microfluidic chip 16 without needing additional automatic micro-channel finding device, such as a microscope. The micro-channel position is associated with the second intensity dip where the fluorescence signal shows optimized sensitivity.

In one embodiment, one receiving fiber delivers collected fluorescence to a mini-spectrometer (Ocean Optics USB4000, 300 nm-1100 nm) for micro-channel alignment verification. When the microfluidic chip 16 is filled a protein sample, the fluorescence can be detected directly with the spectrometer only when the micro-channel is at the optical lens focusing point.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

1. A fluorescence detection system, comprising:
a positionable microfluidic chip configured to define a channel for loading a sample therein;
a light source configured to produce an excitation light;
an optical lens configured to focus the excitation light to the sample to emit fluorescence and to collect the fluorescence;
a fiber bundle probe comprising a transmitting fiber configured to transmit the excitation light to the optical lens, and a first receiving fiber configured to deliver the collected fluorescence;
a first detector configured to detect the fluorescence delivered by the receiving fiber to generate a response signal;
a processing unit configured to determine information about the samples by analyzing the response signal and to generate one or more intensity peaks; and
wherein the chip is positionable based at least in part on one or more of the intensity peaks.

2. The fluorescence detection system of claim 1, wherein the sample comprises a protein.

3. The fluorescence detection system of claim 1, wherein the transmitting fiber is coaxial with the optical lens.

4. The fluorescence detection system of claim 1, wherein the transmitting fiber is off-axis with the optical lens.

5. The fluorescence detection system of claim 1, wherein the channel comprises an axis, and a line connecting central points of distal end planes of the first receiving fiber and the transmitting fiber is perpendicular to the axis of the channel.

6. The fluorescence detection system of claim 4, wherein the fiber bundle probe further comprises a second receiving fibers to deliver the collected fluorescence, and wherein a line connecting central points of distal end planes of the second receiving fiber and the transmitting fiber is parallel to the axis of the channel.

7. The fluorescence detection system of claim 1, wherein a width of the channel is between 20-100 microns, a depth of the channel is between 10-50 microns.

8. The fluorescence detection system of claim 1, wherein a focused light spot size of the excitation light on the channel is about 1.2-2 times larger than a width of the channel.

9. The fluorescence detection system of claim 1, further comprising a dual-phase lock-in amplifier circuit coupled to the detector and a frequency modulator coupled to the dual-phase lock-in amplifier circuit and the light source.

10. The fluorescence detection system of claim 1, wherein the optical lens is integrated into a distal end of the fiber bundle.

11. The fluorescence detection system of claim 1, wherein the first detector comprises an avalanche photodiode.

12. The fluorescence detection system of claim 11, further comprising a second detector comprising an UV-VIS spectrometer.

13. A fluorescence detection method, comprising:
disposing a positionable microfluidic chip defining a channel for loading a sample;
producing an excitation light from a light source;
focusing the excitation light on the sample by an optical lens to emit fluorescence and collecting the fluorescence using the optical lens;
transmitting the excitation light through a transmitting fiber to the optical lens;
passing the collected fluorescence through a first receiving fiber to a detector;
detecting the collected fluorescence to generate a response signal; and
determining information about the sample by analyzing the response signal and generating one or more intensity peaks; and
wherein the chip is positionable based at least in part on one or more of the intensity peaks.

14. The fluorescence detection method of claim 13, wherein the transmitting fiber is coaxial with the optical lens.

15. The fluorescence detection system of claim 13, wherein the transmitting fiber is off-axis with the optical lens.

16. The fluorescence detection method of claim 13, further comprising passing the collected fluorescence through a second receiving fiber, and wherein a line connecting central points of distal end planes of the first receiving fiber and the transmitting fiber is parallel to an axis of the channel.

17. The fluorescence detection method of claim 16, wherein a line connecting central points of distal end planes of the second receiving fiber and the transmitting fiber is perpendicular to the axis of the channel.

18. The fluorescence detection method of claim 13, wherein focusing the excitation light on the sample by an optical lens comprises:
moving the microfluidic chip to an adjacent focal plane of the optical lens from a position away from the adjacent focal plane thereof;
transmitting the excitation light through the transmitting fiber to the optical lens to focus on the chip;
collecting light from the chip by the optical lens;
passing the collected light through the first receiving fiber to the detector;
generating a first intensity peak during movement of the chip;
generating a second intensity peak during further movement of the chip; and
positioning the channel accommodating the sample via indication of the second intensity peak.

19. The fluorescence detection method of claim 18, wherein a first and second intensity peaks denote the excitation light is focused on an upper surface of a cover layer of the chip, and a connection part of the cover layer and a substrate layer of the chip respectively.

20. The fluorescence detection method of claim 19, further comprising producing a third intensity peak to denote the excitation light is focused on a bottom surface of the substrate layer.
